(19) United States
(12) Patent Application Publication
(10) Pub. No.: US 2010/0117600 A1
(43) Pub. Date: May 13, 2010

(54) BATTERY CHARGING CIRCUIT

(76) Inventor: Andras Fazakas, Budapest (HU)

Correspondence Address: FITCH, EVEN, TABIN & FLANNERY, P. O. BOX 18415, WASHINGTON, DC, 20036, US

(21) Appl. No.: 12/597,432

(22) PCT Filed: Apr. 24, 2008
(86) PCT No.: PCT/HU08/00036

§ 371 Date: Oct. 23, 2009

(30) Foreign Application Priority Data
Apr. 24, 2007 (HU) P0700298

(51) Int. Cl. H02J 7/00

(52) U.S. Cl. 320/128

(57) ABSTRACT

Battery charging circuit having a mains transformer with a primary and a secondary winding, at least one capacitor connected in series with a terminal of the secondary winding, and a pair of diodes connected with their different electrodes to an other terminal of the secondary winding, wherein that the other electrodes of the diodes (D1, D2) constitute output terminals for connection to a battery (B) to be charged, the terminal of the capacitor (C1) other than that connected to the secondary winding is connected to one of the output terminals, furthermore the capacitor (C1) is an electrolytic capacitor with at least 100 μF capacitance, and at least one further electrolytic capacitor (C2, C3) with similar capacitance can be connected in parallel to the first capacitor by means of a controlled semiconductor switch (K3), and at least one of the primary and secondary windings (1, 2) comprise tap points lead out and connectable through an associated switch (K1, K2).

The invention relates to a battery charging circuit that comprises a mains transformer with a primary and a secondary winding, at least one capacitor connected in series with a terminal of the secondary winding, and a pair of diodes connected with their different electrodes to another terminal of the secondary winding.

In the international publication document WO 01/06614 a battery charging circuit is described wherein the actual charging voltage was constituted by the vectorial sum of the voltages of a charged electrolytic capacitor and of an energized inductance, wherein this inductance was realized by the secondary winding of a mains transformer. The circuit has utilized both half periods of the AC mains voltage and has provided a unique, high current charging process. The fact that one component of the output voltage is the voltage of a charged capacitor has provided a certain flexibility for the charging process, since the operation of the circuit cannot be damaged by a possible short-circuit of the battery, and the charging process itself has been controlled by the actual terminal voltage of the battery.

This charging has several advantages, however, a drawback lies in that owing to the full-wave operation it uses a high number of components, and in certain fields of applications a similarly flexible but cheaper battery charging circuit would be sufficient.

The control of the aforementioned battery charging circuit was solved among other ways by changing the capacitance of the electrolytic capacitors used. In view of the very high current pulses present during operation the insertion of such electrolytic capacitors with high capacitance specific semiconductor switches should be used that exerts only a minimum limitation to the current peaks. Such a preferred semiconductor-based switching circuit is described in the international publication WO 2005/078888.

The object of the invention is to provide a simple battery charger circuit which retains the basic property of the above referred known battery charger circuit, wherein the actual charging voltage is constituted by the sum of the voltages of a capacitor and of an inductance, whereas it has a simpler and cheaper design and can be used in an economic way for simpler charging tasks.

This object has been solved by providing a battery charging circuit that comprises a mains transformer with a primary and a secondary winding, at least one capacitor connected in series with a terminal of the secondary winding, and a pair of diodes connected with their differing electrodes to another terminal of the secondary winding, and according to the invention the other electrodes of these diodes constitute output terminals of the circuit for connection to a battery to be charged, the terminal of the capacitor other than that connected to the secondary winding is connected to one of the output terminals, wherein this capacitor is an electrolytic capacitor with at least 100 μF capacitance, and at least one further electrolytic capacitor with similarly high capacitance can be connected in parallel to the first capacitor by means of a controlled semiconductor switch, and at least one of the primary and secondary windings comprise tap points lead out and connectable through an associated switch. When the frequency of the alternating current supply is increased, the minimum capacitance value can be decreased proportional to the increase of the frequency.

In a preferable embodiment the voltage of the secondary winding lies between about 50 and 80% of the nominal open circuit voltage of the battery.

There will be more ways for adjustment if each of the primary and secondary windings comprise a plurality of tap lead out terminals connected to respective switches for selecting the required winding section of the associated winding.

For further widening the ways for adjustment at least two of said further electrolytic capacitors can be connected in parallel to the first electrolytic capacitor.

The battery charging circuit according to the invention has a simple and reliable way of operation, and its cheap design makes up for the drawback that the battery is charged during only one of the two half-periods of the AC supply.

A preferable embodiment of the battery charger circuit is applicable for the simultaneous charging of a plurality of series battery cells, wherein the transformer comprises a plurality of secondary winding units, each is associated with a respective one of the cells, and the circuit elements that are connected to the secondary winding are multiplied so that each of the secondary winding units is associated with a respective one of such circuit elements with outputs connected to the associated one of the cells for providing respective independent charging for each cell, furthermore the charging circuit comprises a control unit that monitors and senses the charged states of each cell and adjusts the charging parameters of the concerned circuit elements to ensure substantially uniform charged states for the cells.

The charging circuit according to the invention will now be described in connection with preferable embodiments thereof, wherein reference will be made to the accompanying drawings.

In the drawing:

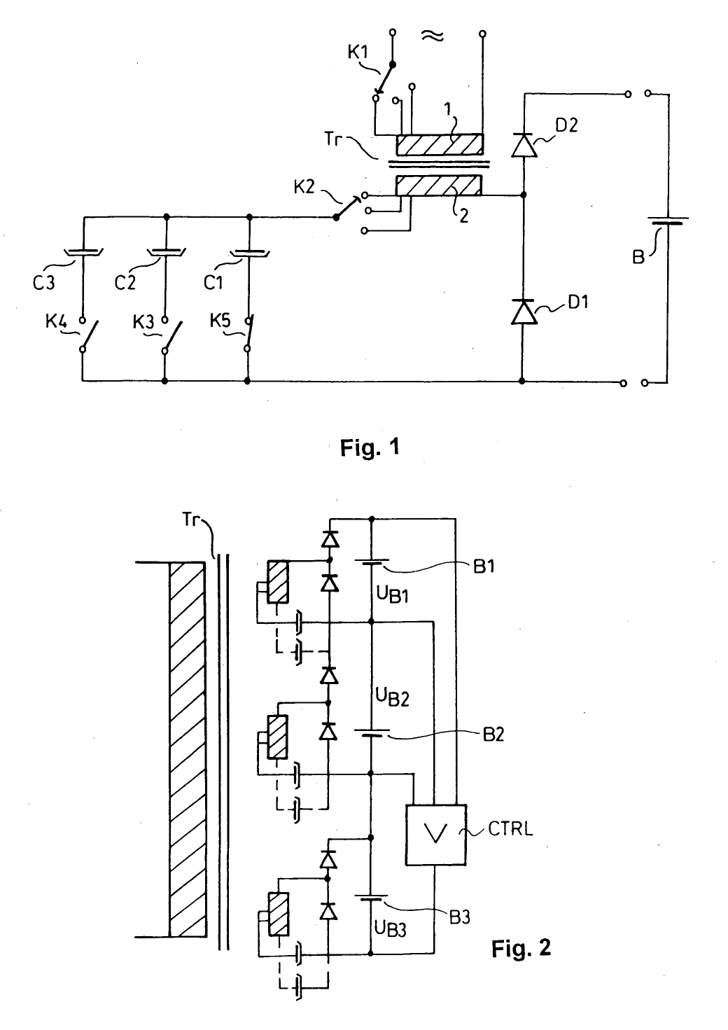

FIG. 1 shows the circuit diagram of a preferred embodiment of the charging circuit, and

FIG. 2. is a sketch illustrating a preferred application.

The battery charger circuit shown in FIG. 1 comprises a mains transformer Tr with a primary winding 1 having a plurality of tapped lead out terminals and a secondary winding 2 also with several tapped lead out terminals. The primary winding 1 is coupled to a single phase alternative current mains line so that the winding section actually connected is selected by a switch K1 connected to the tapped lead out terminals. Similarly the active winding section of the secondary winding 2 can be selected by switch K2, one end of the winding is connected to a common line of series diodes D1 and D2 and the other selected end is connected to a first (positive) terminal of a plurality of capacitors C1, C2 and C3, all having a high capacitance value. The electrolytic capacitors C1, C2 and C3 are connected in parallel with each other through switches K3 and K4 each built as a semiconductor switching circuit, whereby either or both of the capacitors C2 and C3 can be connected in parallel with the first capacitor C1 which is practically permanently connected. The switches K3, K4 are designed preferably as disclosed in the previously referred international publication WO 2005/078888. Such a switching circuit includes a small series inductance that limits the rising steepness of the initial current pulse. Although during operation the first capacitor C1 is permanently connected, for limiting the current jump when the battery charger is first switched on a similarly designed switch K5 is used. The other (negative) terminal of the parallel electrolytic capacitors C1, C2, C3 is coupled to the anode of the diode D1 and to the negative terminal of battery B to be charged. The positive terminal of the battery B is connected to the cathode of the other diode D2.

The circuit shown in FIG. 1 has a close similarity to the voltage doubler circuit used frequently in low current applications.

For understanding the charging of the battery B and the operation of the circuit let us suppose that only the electrolytic capacitor C1 is connected and it is energy-free (discharged) state, furthermore that the alternating voltage on the secondary winding 2 a sine period has just started wherein the polarity of the rising voltage is such that the winding terminal connected to the capacitor C1 is positive and the other terminal is negative. In this half-period an increasing current starts to flow in the secondary winding 2 that flows through the diode D1 and charges the electrolytic capacitor C1. When the voltage has reached its peak value, the electrolytic capacitor C1 cannot be charged any more and the circuit of the diode D1 gets broken. In the second half of the half period current cannot still flow. In the next half period the polarity of the voltage on the secondary winding reverses and its actual instantaneous values get added to the voltage of the charged electrolytic capacitor C1. When the value of this combined voltage reaches the terminal voltage of the Battery B, or more accurately the combined voltage is higher than the battery voltage by the forward bias voltage of the diode D2, then the diode D2 opens and the series system consisting of the electrolytic capacitor C1 and the secondary winding 2 will charge the battery B. Energy will flow in the battery B not only from the secondary winding 2 but also from the electrolytic capacitor C1. In the subsequent half period the secondary winding 2 will charge again the electrolytic capacitor C1 and supplies the energy which has been used in the previous half period for charging the battery B.

The charging takes place as long as the aforementioned combined voltage is not smaller than the voltage of the battery B. The higher the voltage of the battery B is, the shorter will be the time section when this condition applies and this section is also referred to as the flowing angle of the charging current. Thereby the circuit automatically controls the charging energy, the charging will take place with maximum energy when it is most required by the battery B i.e. at its lowest charge state when the terminal voltage takes the lowest value.

The charging circuit according to the invention provides several ways of adjusting the charging parameters. The permanently connected electrolytic capacitor C1 has a large capacitance, it can be between about 100 μF to 1000 μF or even larger, and the capacitors C2 and C3 that can be connected in parallel therewith have similarly large capacitance. The minimum capacitance depends on the frequency of the mains voltage. The exemplary values given above relate to a mains frequency of 50/60 Hz. With increased frequency the capacitance values can be decreased in a proportional way. By increasing the storage capacity the energy that can be used for charging the battery B in a half period can be increased. The active charging time sections can be increased if the voltage of the secondary winding 2 is increased by changing the position of the switch K2. The excitation of the primary winding 1 of the transformer Tr and the charging power can be adjusted by the switch K1.

Concerning the number of components used the charging circuit according to the invention is more economic than the charger described in the above referred publication WO 01/06614 as it uses only half as many capacitors and diodes. As a downsize of this feature the present charger circuit utilizes only one of the two half periods of the mains voltage, therefore this charger cannot be used as a fast charger.

The effective value of the alternating voltage across the terminals of the secondary winding 2 of the transformer Tr should be preferably between about 50-80% of the terminal voltage of the battery B measured with no load.

FIG. 2 shows a preferred exemplary application of the charging circuit according to the invention. It is a well-known fact that batteries are used generally in series connection to form series chains of batteries, and most charger circuit charges the series chain as if it was a single battery. Such a charging is acceptable as long as the individual battery cells are identical and store equal charges during the charging process. If there is a difference in the properties of the cells used or with time the initially identical cells will be different, then the life time of the chain will be defined by the life time of the cell with the smallest charging capacity. A charging current that would be able to charge some of the existing cells will overcharge and damage the weakest cell which has become fully charged. For the individual charging of the respective cells in a series chain the use of as many battery charger circuits as the number of the cells would be a too expensive requirement, therefore the cell-by-cell charging is rarely used because of cost reasons, although such a charging would be preferable concerning the life time of the chain.

FIG. 2 shows a version of the circuit of FIG. 1, wherein the battery B has cells B1, B2 and B3, and the transformer Tr has three identical secondary windings and each of them is connected to a charger circuit with capacitors and diodes as shown in detail in FIG. 1, whereas the components have been shown in FIG. 2 in a schematic way only. It has been explained previously that the charging parameters can be controlled by adjusting the capacitance used and by appropriately choosing the secondary voltage by selecting the required tap point. The circuit of FIG. 2 comprises a control unit CTRL that monitors the voltages UB1, UB2 and UB3 of the respective cells B1, B2 and B3 and if any difference is sensed, then by utilizing the listed ways of adjustment it can make sure that the charged state of the respective cells be always the same during the charging process, and the charging be terminated when the end of charge condition is sensed at the weakest cell. Such a solution will greatly increase the life time of the series system and its reliability, and at the same time the low number of components will not cause substantial excess costs.

The charging circuit according to the invention has a simple design and it can provide a sufficiently fast charging for most batteries. One has to admit that the utilization of the available mains supply is better in case of chargers using both half periods for charging, but there are several applications, wherein the cheap design and low costs constitute the basic consideration when choosing between different models.

1. Battery charging circuit comprising a mains transformer with a primary and a secondary winding, at least one capacitor connected in series with a terminal of the secondary winding, and a pair of diodes connected with their different electrodes to an other terminal of the secondary winding, characterized in that the other electrodes of said diodes (D1, D2) constitute output terminals of said circuit for connection to a battery (B) to be charged, the terminal of said capacitor (C1) other than that connected to the secondary winding is connected to one of said output terminals, furthermore said capacitor (C1) is an electrolytic capacitor with at least 100 μF capacitance and at least one further electrolytic capacitor (C2, C3) with similar capacitance can be connected in parallel to the first capacitor by means of a controlled semiconductor switch (K3), and at least one of said primary and secondary windings (1, 2) comprise tap points lead out and connectable through an associated switch (K1, K2).

2. The battery charger circuit as claimed in claim 1, wherein the voltage of said secondary winding (2) lies between 50 and 80% of the nominal open circuit voltage of said battery (B).

3. The battery charger circuit as claimed in claim 1, wherein both said primary and secondary windings (1, 2) comprise a plurality of tap lead out terminals connected to respective switches (K1, K2) for selection the required winding section of the associated winding.

4. The battery charger circuit as claimed in claim 1, wherein at least two of said further electrolytic capacitors (C2, C3) can be connected in parallel to said first electrolytic capacitor (C1).

5. The battery charger circuit as claimed in claim 1 for the simultaneous charging of a plurality of series battery cells, wherein said transformer (Tr) comprises a plurality of secondary winding units, each being associated with a respective one of said cells, and the circuit elements that being connected to the secondary winding (2) are multiplied so that each of said secondary winding units is associated with a respective one of said circuit elements with outputs connected to the associated one of said cells for providing respective independent charging for each cell, further comprising a control unit (CTRL) monitoring and sensing the charged states each of said cells and adjusting the charging parameters of said circuit elements to ensure substantially uniform charged states for said cells.
